(19) United States
(12) Patent Application Publication
(10) Pub. No.: US 2018/0031747 A1
(43) Pub. Date: Feb. 1, 2018

(54) QUANTUM DOT POLARIZATION PLATE

(71) Applicant: Shenzhen China Star Optoelectronics Technology Co., Ltd., Shenzhen City (CN)

(72) Inventor: Bai Bai, Shenzhen City (CN)

(21) Appl. No.: 14/908,129

(22) PCT Filed: Dec. 28, 2015
(86) PCT No.: PCT/CN2015/099281

§ 371 Date: Jan. 28, 2016

(30) Foreign Application Priority Data
Dec. 8, 2015 (CN) 201510898214.X

(51) Int. Cl. G02B 5/30; G02B 1/14; G02F 1/1335; G02B 5/02

(52) U.S. Cl. CPC G02B 5/3033; G02B 5/0242; G02B 1/14; G02F 1/133528

(57) ABSTRACT

The present invention provides a quantum dot polarization plate, which includes a polarization film (10) and a quantum dot bright enhance film (20) laminated on the polarization film (10). The polarization film (10) includes a polarization layer (11) and a first protection layer (12) and a second protection layer (13) respectively located at opposite sides of the polarization layer (11). The quantum dot bright enhance film (20) is attached to the second protection layer (13). The quantum dot bright enhance film (20) is a film containing therein quantum dots (201). The quantum dot polarization plate is formed by attaching the quantum dot bright enhance film to the polarization film so as to reduce the operations for forming the quantum dot polarization plate. The quantum dot polarization plate provides light polarization and effectively expands color gamut coverage rate and also realize wide view angle of the display device and can be manufacturing with simple operations.

### BACKGROUND OF THE INVENTION

### 1. Field of the Invention

The present invention relates to the field of display technology, and in particular to a quantum dot polarization plate.

### 2. The Related Arts

With the progress of technology and science, people get increasingly relying upon communication and transmission of information. Display devices, which serve as a primary carrier and physical basis for exchange and transmission of information, are becoming a hot spot and high land that are pursued by scientists who devote themselves to the study and researches of information photoelectronics.

Quantum dots (QDs) are nanometer semiconductor crystal having a particle size smaller than or close to the Bohr radius, and most of them are three-dimensional nanometer-sized material constituted by elements of II-VI groups or III-V groups. Due to the quantum confinement effect, the transportation of electrons and holes is restricted so that the continuous energy band is converted into discrete energy levels. When the size of quantum dot is different, the quantum confinement of electrons and holes is also different so that the discrete energy level structure is also different. When excited by external energy, quantum dots of different sizes would give of different wavelengths of light, namely different colors of light.

The advantage of the quantum dots is that through adjustment of the size of the quantum dot, it is possible to provide an emission wavelength range that covers infrared band and the entire band of visible light and the emission light has a narrow band and high saturation of color. The quantum dot material has a high quantum conversion efficiency and the property of the material is stable. The manufacturing processes are simple and variable, allowing for production to be made from solutions, making the resources very rich.

However, light, after passing through a quantum dot, is emitted randomly in direction. On the other hand, the operation principle of a liquid crystal display (LCD) device is based on rotation of polarization and birefringence so that through application of an electrical voltage to control the rotation of liquid crystal, linear polarized light passing through an upper polarizer would be rotated to transmit through a lower polarizer (that has a polarization direction perpendicular to the upper polarizer), whereby the upper and lower polarizers and a liquid crystal cell collectively function as an optic switch. It is quite apparent that such an optic switch is generally ineffective to light emitting from a quantum dot. When spread light that passes through a quantum dot travels through liquid crystal, it no longer possible to have the light passing through a pixel well controlled and LCD would suffer leakage of light.

As shown in FIG. 1, taking a lower polarizer as an example, a regular polarization plate is made up of multiple layers of films combined together, generally including the following layers, which are, in sequence from top to bottom, a surface protection film 110, a first protection layer 120, a polarization layer 130, a second protection layer 140, an adhesive layer 150, and a peeling protection film 160. To attach, as shown in FIG. 2, the peeling protection film 160 is peeled off to expose the adhesive layer 150 so that the polarization plate is attached, by the adhesive layer 150, to a substrate to be attached to. After the attachment, the surface protection film 110 is often removed. In the structure of the polarization plate, the core portion is the polarization layer 130, which is generally a polyvinyl alcohol (PVA) layer containing therein iodine molecules that has an effect of light polarization. The first protection layer 120 and the second protection layer 140 are both transparent triacetyl cellulose (TAC) layers primarily for maintaining the polarizer of the polarization layer 130 in a stretched condition, preventing the polarizer from losing moisture, and protecting it from external influence. Further, to reduce the thickness of a display device and to improve the optical characteristics of the display device, it is commonplace to attach a bright enhance film 170 to the protection layers 120/140 to form a bright-enhance-film included polarizer. Among the bright enhance films that are available in the market, the most famous one, the DEBF optic film available from 3M company, provides an excellent effect of brightness enhancement and is widely used in display devices.

### SUMMARY OF THE INVENTION

An object of the present invention is to provide a quantum dot polarization plate, which comprises a quantum dot bright enhance film for substitute of a conventional bright enhance film for application in a display device in order to provide light polarization and also to expand color gamut coverage rate and reduce the operations for forming polarization plates.

To achieve the above object, the present invention provides a quantum dot polarization plate, which comprises a polarization film and a quantum dot bright enhance film laminated on the polarization film;

the polarization film comprising a polarization layer and a first protection layer and a second protection layer respectively located at opposite sides of the polarization layer, the quantum dot bright enhance film being attached to the second protection layer, the quantum dot bright enhance film being a film containing therein quantum dots

The quantum dots contained in the quantum dot bright enhance film is formed of a semiconductor material or more than two semiconductor materials or carbon quantum dot material, the semiconductor materials comprising II-VI group semiconductor materials and III-V group semiconductor materials.

The II-VI group semiconductor materials comprise CdS, CdSe, CdTe, or ZnSe, and the III-V group semiconductor materials comprise InP or InAs.

The quantum dots are subjected to modification through surface grafting or surface coating.

The quantum dots are oil soluble or water soluble.

The quantum dots comprise nanometer particles having a size in the range of 0-20 nm.

An operation for forming the quantum dot bright enhance film comprises one of spray coating, spin coating, printing, and slot die coating.

The quantum dot polarization plate is used as a lower polarizer of a liquid crystal display panel.

The polarization layer comprises an iodine-series polarization film or a dye-series polarization film; and the polarization layer is formed of a material comprising polyvinyl alcohol.

The first protection layer and the second protection layer are formed of a material comprising triacetyl cellulose.

The present invention also provides a quantum dot polarization plate, which comprises a polarization film and a quantum dot bright enhance film laminated on the polarization film;

the polarization film comprising a polarization layer and a first protection layer and a second protection layer respectively located at opposite sides of the polarization layer, the quantum dot bright enhance film being attached to the second protection layer, the quantum dot bright enhance film being a film containing therein quantum dots;

wherein the quantum dots comprise nanometer particles having a size in the range of 0-20 nm;

wherein an operation for forming the quantum dot bright enhance film comprises one of spray coating, spin coating, printing, and slot die coating;

wherein the quantum dot polarization plate is used as a lower polarizer of a liquid crystal display panel;

wherein the polarization layer comprises an iodine-series polarization film or a dye-series polarization film; and the polarization layer is formed of a material comprising polyvinyl alcohol; and

wherein the first protection layer and the second protection layer are formed of a material comprising triacetyl cellulose.

The efficacy of the present invention is that the present invention provides a quantum dot polarization plate, which comprises a polarization film and a quantum dot bright enhance film laminated on the polarization film and is formed by attaching the quantum dot bright enhance film to the polarization film so as to reduce the operations for forming the quantum dot polarization plate. The quantum dot bright enhance film is a film that contains therein quantum dots for substitute of a conventional bright enhance film for application in a display device. The quantum dot polarization plate provides light polarization and effectively expands color gamut coverage rate and also realize wide view angle of the display device and can be manufacturing with simple operations.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a cross-sectional view showing the structure of a conventional polarization plate;

FIG. 2 is a schematic view showing a conventional polarization plate used in a liquid crystal display panel;

FIG. 3 is a cross-sectional view illustrating the structure of a quantum dot polarization plate according to the present invention; and

FIG. 4 is a schematic view showing a quantum dot polarization plate of the present invention used in a liquid crystal display panel.

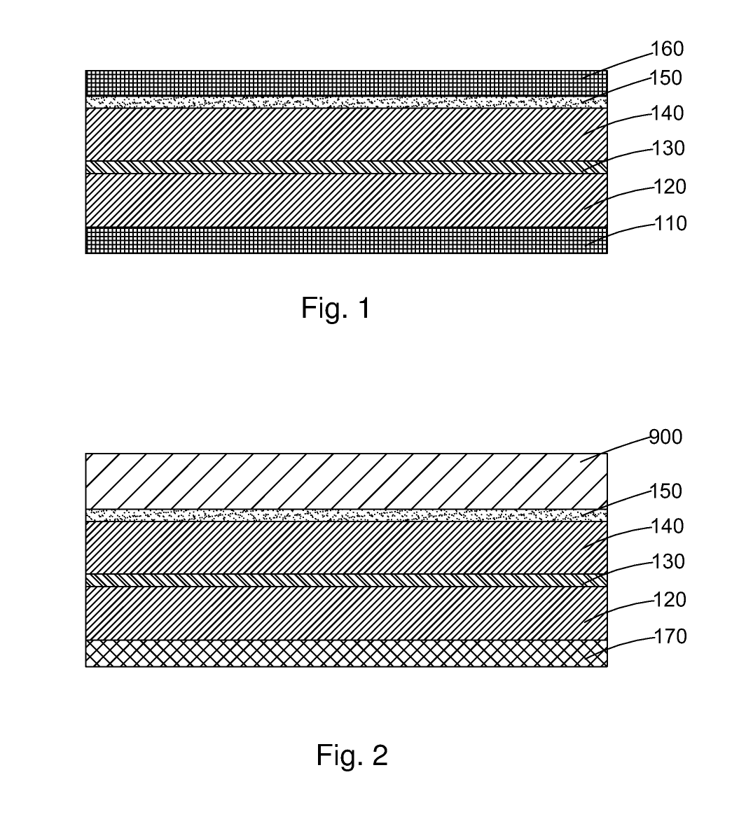

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

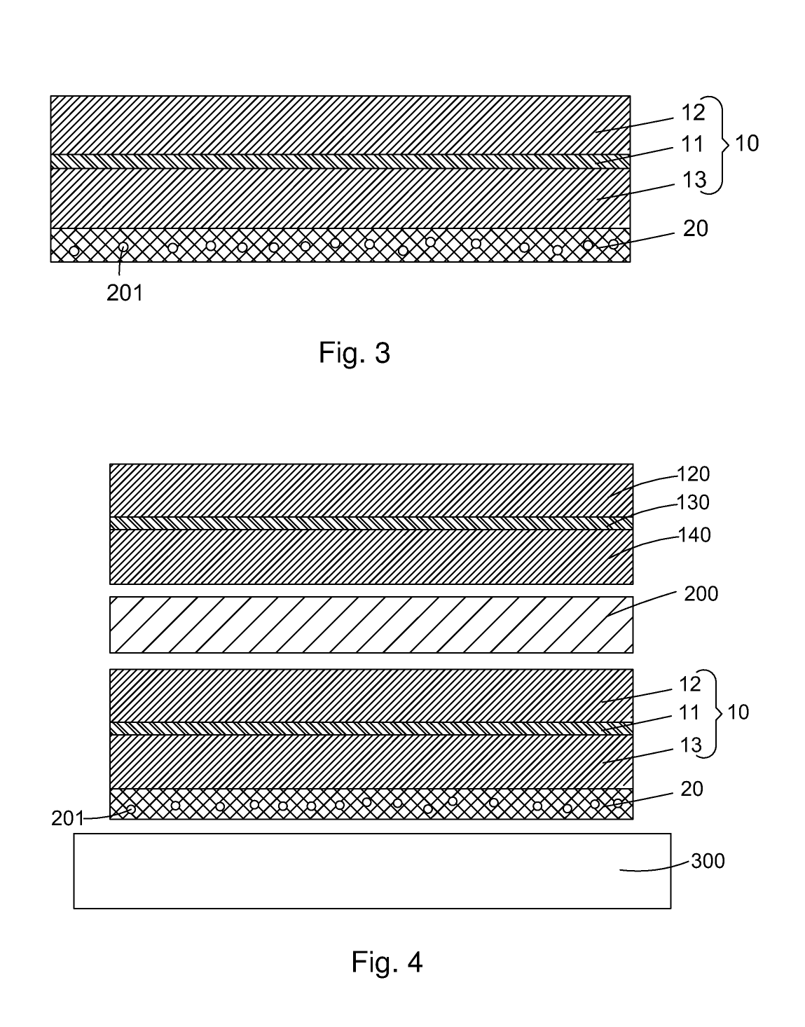

Referring to FIG. 3, the present invention provides a quantum dot polarization plate, which comprises a polarization film 10 and a quantum dot bright enhance film 20 laminated on the polarization film 10.

The polarization film 10 comprises a polarization layer 11 and a first protection layer 12 and a second protection layer 13 respectively located on opposite sides of the polarization layer 11. The quantum dot bright enhance film 20 is attached to the second protection layer 13. The quantum dot bright enhance film 20 comprises a film that contains therein quantum dots 201 and can be a quantum dot film formed by mixing quantum dots with other material and then subjected to a film forming operation, or can alternatively be a quantum dot film solely formed of quantum dots.

Specifically, the quantum dots 201 contained in the quantum dot bright enhance film 20 is formed of a semiconductor material, such as II-VI group semiconductor materials (such as CdS, CdSe, CdTe, and ZnSe), or III-V group semiconductor materials (such as InP and InAs), or can alternatively formed of two or more than two semiconductor materials, or can further alternatively be formed of carbon quantum dot materials or materials of other elements.

Specifically, the quantum dots 201 contained in the quantum dot bright enhance film 20 can be one single type or a mixture of multiple types. Preferably, the quantum dots 201 of the quantum dot bright enhance film 20 is combination of multiple types of quantum dots to provide a better effect of color gamut enhancement and mixture.

Specifically, the quantum dots 201 can be quantum dots that are subjected to modification through surface grafting or surface coating so as to have them provide a more uniform and more stable mixing effect in the solvent.

Specifically, the quantum dots 201 are oil soluble or water soluble.

Preferably, the quantum dots 201 are nanometer particles having a particle size between 0-20 nm.

Specifically, the film formation operation of the quantum dot bright enhance film 20 includes spray coating, spin coating, printing, or slot die coating.

Specifically, the polarization layer 11 comprises an iodine-series polarization film or a dye-series polarization film; and the polarization layer 11 is formed of a material comprising polyvinyl alcohol.

Specifically, the first protection layer 12 and the second protection layer 13 are formed of a material comprising triacetyl cellulose.

Specifically, the quantum dot polarization plate may serve as a lower polarizer of a liquid crystal display panel. Since the quantum dots contained in the quantum dot bright enhance film 20 has the property of light emission, it provides an effect of increasing color gamut coverage.

As shown in FIG. 4, the quantum dot polarization plate of the present invention, when serving as a lower polarizer of a liquid crystal display panel, is arranged between a liquid crystal display panel 200 and a backlight module 300. The quantum dot bright enhance film 20 is attached to the side of the polarization film 10 that is adjacent to the backlight module 300. An upper polarizer may be a conventional polarization plate that comprises a first protection layer 120, a polarization layer 130, and a second protection layer 140.

Specifically, the quantum dot polarization plate of the present invention is applicable to a BOA (Black matrix On Array), COA (Color filter On Array), or GOA (Gate Driver on Array) liquid crystal panel.

In summary, the present invention provides a quantum dot polarization plate, which comprises a polarization film and a quantum dot bright enhance film laminated on the polarization film and is formed by attaching the quantum dot bright enhance film to the polarization film so as to reduce the operations for forming the quantum dot polarization plate. The quantum dot bright enhance film is a film that contains therein quantum dots for substitute of a conventional bright enhance film for application in a display device. The quantum dot polarization plate provides light polarization and also effectively expands color gamut coverage rate and can be manufacturing with simple operations.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A quantum dot polarization plate, comprising a polarization film and a quantum dot bright enhance film laminated on the polarization film;
the polarization film comprising a polarization layer and a first protection layer and a second protection layer respectively located at opposite sides of the polarization layer, the quantum dot bright enhance film being attached to the second protection layer, the quantum dot bright enhance film being a film containing therein quantum dots.

2. The quantum dot polarization plate as claimed in claim 1, wherein the quantum dots contained in the quantum dot bright enhance film is formed of a semiconductor material or more than two semiconductor materials or carbon quantum dot material, the semiconductor materials comprising II-VI group semiconductor materials and III-V group semiconductor materials.

3. The quantum dot polarization plate as claimed in claim 2, wherein the II-VI group semiconductor materials comprise CdS, CdSe, CdTe, or ZnSe, and the III-V group semiconductor materials comprise InP or InAs.

4. The quantum dot polarization plate as claimed in claim 1, wherein the quantum dots are subjected to modification through surface grafting or surface coating.

5. The quantum dot polarization plate as claimed in claim 4, wherein the quantum dots are oil soluble or water soluble.

6. The quantum dot polarization plate as claimed in claim 1, wherein the quantum dots comprise nanometer particles having a size in the range of 0-20 nm.

7. The quantum dot polarization plate as claimed in claim 1, wherein an operation for forming the quantum dot bright enhance film comprises one of spray coating, spin coating, printing, and slot die coating.

8. The quantum dot polarization plate as claimed in claim 1, wherein the quantum dot polarization plate is used as a lower polarizer of a liquid crystal display panel.

9. The quantum dot polarization plate as claimed in claim 1, wherein the polarization layer comprises an iodine-series polarization film or a dye-series polarization film; and the polarization layer is formed of a material comprising polyvinyl alcohol.

10. The quantum dot polarization plate as claimed in claim 1, wherein the first protection layer and the second protection layer are formed of a material comprising triacetyl cellulose.

11. A quantum dot polarization plate, comprising a polarization film and a quantum dot bright enhance film laminated on the polarization film;
the polarization film comprising a polarization layer and a first protection layer and a second protection layer respectively located at opposite sides of the polarization layer, the quantum dot bright enhance film being attached to the second protection layer, the quantum dot bright enhance film being a film containing therein quantum dots;
wherein the quantum dots comprise nanometer particles having a size in the range of 0-20 nm;
wherein an operation for forming the quantum dot bright enhance film comprises one of spray coating, spin coating, printing, and slot die coating;
wherein the quantum dot polarization plate is used as a lower polarizer of a liquid crystal display panel;
wherein the polarization layer comprises an iodine-series polarization film or a dye-series polarization film; and the polarization layer is formed of a material comprising polyvinyl alcohol; and
wherein the first protection layer and the second protection layer are formed of a material comprising triacetyl cellulose.

12. The quantum dot polarization plate as claimed in claim 11, wherein the quantum dots contained in the quantum dot bright enhance film is formed of a semiconductor material or more than two semiconductor materials or carbon quantum dot material, the semiconductor materials comprising II-VI group semiconductor materials and III-V group semiconductor materials.

13. The quantum dot polarization plate as claimed in claim 12, wherein the II-VI group semiconductor materials comprise CdS, CdSe, CdTe, or ZnSe, and the III-V group semiconductor materials comprise InP or InAs.

14. The quantum dot polarization plate as claimed in claim 11, wherein the quantum dots are subjected to modification through surface grafting or surface coating.

15. The quantum dot polarization plate as claimed in claim 14, wherein the quantum dots are oil soluble or water soluble.
